(19) United States
(12) Patent Application Publication
(10) Pub. No.: US 2008/0132181 A1
(43) Pub. Date: Jun. 5, 2008

(54) METHOD AND SYSTEM FOR CONFIGURABLE CALLING MODE

(75) Inventors: YI-ZHE SHEN, NANJING (CN); LUIS A. PICHARDO, MIRAMAR, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/747,099

(22) Filed: May 10, 2007

Related U.S. Application Data
(60) Provisional application No. 60/868,070, filed on Nov. 30, 2006.

(51) Int. Cl. H04B 1/38

(52) U.S. Cl. 455/90.2

(57) ABSTRACT

A system (100) and method (200) for managing group call is provided. The method can include assigning (210) time windows (140) to a plurality of mobile devices (110) in a group call, and balancing PTT requests (220) among the plurality of mobile devices in accordance with the time windows to reduce talking request contention. The time window can include a talk window 141 and a listen window 142 to identifies whether a mobile device can be in talking mode (620). The method can include randomizing (214) a start of the time windows among the plurality of mobile devices, and staggering (216) time windows devices during a hang-time (370) of the group call. The randomization and staggering can be based on user activity (230) or user preference settings (232). A user interface (500) can allow a user to preview a look and feel of the time window, using haptic representations such as audio, visual, or vibration effect.

### CROSS REFERENCE TO RELATED APPLICATIONS

This application claims the benefit of U.S. Provisional Patent Application No. 60/868,070, filed Nov. 30, 2006, the entire contents of which are incorporated by reference herein.

### FIELD OF THE INVENTION

The present invention relates to wireless communication systems, and more particularly, to managing operation of multiple communication devices.

### BACKGROUND OF THE INVENTION

The use of portable electronic devices and mobile communication devices has increased dramatically in recent years. Two primary means of voice communication are generally offered in mobile devices: Interconnect and dispatch. Interconnect is a communication mode by which both parties can speak at the same time. It is considered a two-way communication since both parties can talk and listen on a separate talk channel and a separate receive channel. Interconnect communication is also available for three-way calling or group call. In contrast, dispatch mode is a communication mode be which only one party can speak at a time. The other party can only listen until the first party finishes talking. In practice, a push-to-talk (PTT) key is pressed to acquire control of a talk channel. The talk channel is not released until the PTT key is released. Upon release, another participant can acquire the PTT channel. Dispatch mode is also available for three-way dispatch or group dispatch.

Selected Dynamic Group Call (SDGC) is a form of dispatch call. SDGC provides a way for all participating mobile devices to talk to each other as on a group call, but it is characterized by creating the group dynamically. SDGC provides fast call setup and operation that is superior to traditional 3-way interconnect or conference calling. Similarly, SDGC only allows one participant to talk at a time. Only after the participant releases the PTT key, can other participants receive an opportunity to speak. The participant who acquires the channel by pushing the PTT key first will have the chance to talk. In such regard, the participants ‘race’ to acquire the talk channel by being the first to press the PTT key. Participants that are quick to respond generally receive more opportunities to speak. Also participants that are more active in the conversation and press the PTT key more often receive more opportunities to speak. As a result, the others participants are generally challenged to acquire PTT control. In such regard, these participants do not get an equal chance to enter the dialogue, or catch up with a topic being discussed. Moreover, as more participants join the dispatch group call, participants race to acquire the channel places which introduce more contention for the PTT channel.

During a hang-time, a mobile device may indicate that the talk channel is available. The hang-time is a time between when the talk channel for PTT is released and when the talk channel is acquired. However, due to an additional delay, users may not be able to acquire the talk channel upon pressing the PTT key. The delay is generally associated a control setup time in response to the pressing of a PTT key. Accordingly, a participant's request to acquire the PTT may not be recognized due to the delay and the contention for the talk channel by the other participants. Moreover, a talk channel may identify a “ready for talk” status during the hang-time period, which can be up to 6 seconds. The “ready for talk” status can be misleading since a participant cannot actually acquire the PTT after pressing the PTT key, even given a “ready for talk” status. As a result, a participant can become confused or annoyed, and lose interest in group call participation.

### SUMMARY

Broadly stated embodiments of the invention are directed to a system and method for configurable calling mode. One embodiment is directed to a method for managing a push-to-talk (PTT) group call. The method can include assigning time windows to a plurality of mobile devices in a PTT group call, and balancing PTT requests among the plurality of mobile devices in accordance with the time windows to reduce talking request contention. The time window can identify whether a mobile device is in a talking mode or a listening mode. The step of balancing PTT requests can include identifying a time window for talking and listening for each mobile device. The time window includes a talk window for providing a talking interval, and a listen window for providing a listening interval. The mobile device can enter the talking mode in response to a PTT request during the talk window. The method can include randomizing a start of the time windows among the plurality of mobile devices, and staggering time windows for the plurality of mobile devices during a hang-time of the PTT group call.

The method can further include dynamically adjusting the time window based on user activity. In one arrangement, the method can include logging a number of unsuccessful PTT requests to enter talking mode, and automatically adjusting the time window in accordance with the number of PTT requests. In one aspect, an indicator can be presented for identifying the talk and listen window. For example, a PTT status light can be changed to coincide with the talk window or the listen window, wherein at least one PTT status light identifies when the PTT request activates talking mode. The method can further configuring the time window based on user adjustable settings of the mobile device. In one arrangement, the method can include detecting a user request for configuring the time window, providing a haptic representation of the talking interval and the listening interval, and adjusting the time window in accordance with user feedback. A haptic representation can be an audio, visual, or vibration effect.

One embodiment is directed to a system for push-to-talk (PTT) group call. The system can include a plurality of mobile devices each having a PTT key to make a PTT request, wherein the plurality of mobile devices can each have a controller that enforces a time window for a PTT request. The time window can identify a talking interval and a listening interval. A first mobile device can generate the time windows for the plurality of mobile devices and balance multiple PTT requests among the plurality of mobile devices in view of the time windows to reduce talking request contention during the PTT group call. Each mobile device can include a controller for identifying mobile devices in the PTT group call and determining when a mobile device is in a talking mode or a listening mode. Each mobile device can include a timer for tracking talking windows and listening windows of the plurality of mobile devices. The controller can stagger time windows during a hang-time of the PTT group call such that a number of talking intervals is randomly distributed across a duration of the PTT group call. The controller can automatically adjust the time windows for plurality of mobile devices based on user activity or user preference settings. In one arrangement, the controller can change an order of the talking interval and the listening interval in a time window to increase talking mode probability.

Another embodiment is directed to a mobile device. The mobile device can include a controller for sending and receiving audio data during a push-to-talk (PTT) group call, a push-to-talk (PTT) key operatively coupled to the controller for activating a talking mode, and a controller operatively coupled to the PTT key and the controller for controlling when the PTT key activates the talking mode in accordance with a time window. The mobile device can further include a timer communicatively coupled to the controller for establishing a time window, the time window having a talking interval and a listening interval. The PTT key activates the talking mode when the timer is within the talking interval, and disables talking mode when the timer is within the listening interval. The mobile device can include a user interface for adjusting the time window and saving user preference settings associated with the adjusting. The user interface can provide a haptic representation of the time window during the adjusting, wherein the haptic representation is an audio, visual, or vibration effect. In one aspect, a visual representation is presented through a back light, such that a first illumination of the back light identifies when a user can enter talking mode, and a second illumination of the back light identifies when a user cannot enter talking mode. The user interface can also present an in-call screen during the PTT group call having icons or messages that identify when a PTT request activates talking mode.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a block diagram of a wireless communication system in accordance with the embodiments of the invention;

FIG. 2 is an illustration of a peer-to-peer ad-hoc network for wireless communication in accordance with the embodiments of the invention;

FIG. 3 is a mobile device for managing group call in accordance with the embodiments of the invention;

FIG. 4 is a time window illustrating a talk interval and a listen interval in accordance with the embodiments of the invention;

FIG. 5 is a method for managing group call in accordance with the embodiments of the invention;

FIG. 6 is method for assigning time windows in accordance with the embodiments of the invention;

FIG. 7 is a diagram showing an assignment of time windows to a plurality of mobile devices sharing a talk channel in accordance with the embodiments of the invention;

FIG. 8 is a method for balancing push-to-talk (PTT) requests based on user settings in accordance with the embodiments of the invention;

FIG. 9 is a method for balancing push-to-talk (PTT) requests based on user activity in accordance with the embodiments of the invention;

FIG. 10 is an exemplary procedure for adjusting and previewing user settings in accordance with the embodiments of the invention; and

FIG. 11 is an illustration of adjusting and previewing user settings in accordance with the embodiments of the invention.

FIG. 12 is an illustration of an in-call screen for a talk window and a listen widow in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “frequency” can be defined as a fundamental operational frequency or at least one harmonic of the fundamental. The term “code-plug” can be defined as a non-volatile memory storage.

The term “talk channel” can be defined as a transmit communication channel that is shared amongst a plurality of mobile devices. The term “hang-time” can be defined as the time between when a talk channel is released until the talk channel is again acquired. The term “PTT request” can be defined as an attempt to push to talk, either by hardware or software. The term “PTT key” can be defined as a physical button or a soft-key. The term “soft-key” can be defined as a software controlled button. The term “start time” can be defined as a point in time at which a time window is activated. The term “time window” can be defined as an interval of time comprising at least one talk window and at least one listen window. The term “talk window” can be defined as an interval of time in which a PTT request can be accepted. The term “listen window” can be defined as an interval of time in which a PTT request is not accepted. The term “group call” can be defined as any exchange of communication that shares at least one talk channel. The term “PTT group call” can be defined as a group call based on push-to-talk requests. The term “haptic” can be defines as conveying information by sensory means such as audio, visual, or physical.

Broadly stated, embodiments of the invention are directed to a system and method for balancing talking requests and listening requests in a group call. The method provides a configurable way for users to balance the speaking and listening requests through randomized ‘talk/listen windows’. The talk windows can be randomly distributed within a hang-time to reduce contention for a talk channel. This reduces the number of users that can acquire the PTT channel. The configuration of the talk and listen windows can increase the probability for each user to have a chance to speak during a hang-time of group call session. The system also allows users to customize the length and number of the ‘windows’ to meet their own preferences. Moreover, a mobile device in the system can automatically adjust the ‘talk/listen windows’ in accordance with the user's activity during the SDG call. This provides the user with more chances to talk or listen based on their preferred settings. Furthermore, the mobile device can provide indicators in accordance with the durations of the talk and listen windows. In such regard, the mobile device can inform the user when an opportunity to talk is available. The indicators can include enhanced LED flashing, PTT backlight flashing, vibrating effects, and a visual display of status icons.

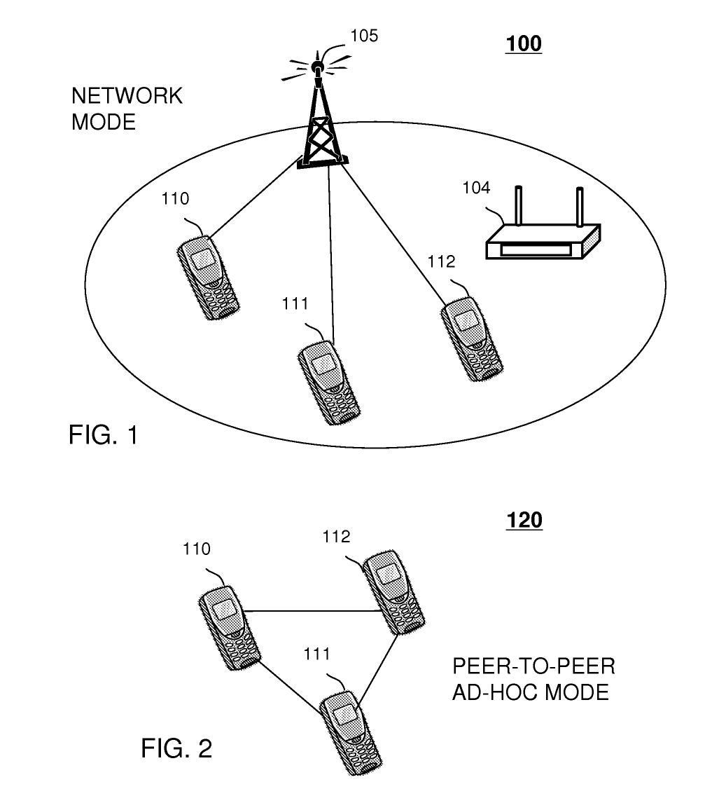

Referring to FIG. 1, a wireless communication system 100 for providing interconnect and dispatch communication is shown. The wireless system 100 can provide wireless connectivity or dispatch connectivity over a radio frequency (RF) communication network. The wireless communication system 100 can include a plurality of mobile devices 110-112 for providing voice communication. In one arrangement, the mobile devices 110-112 can communicate with one or more cellular towers 105 using a standard communication protocol such as CDMA, GSM, or iDEN, but is not herein limited to these. The cellular towers 105, in turn, can connect the mobile devices 110-112 through a cellular infrastructure to other mobile devices or resources on other networks (not shown).

The mobile devices 110-112 can also connect amongst one another over a Wide Local Area Network (WLAN) 104 within an ah-hoc group. A WLAN provides wireless access within a local geographical area. The mobile devices 110-112 can communicate with the WLAN 104 according to the appropriate wireless communication standard. The WLAN 104 can coordinate a sending and receiving of voice packets between the mobile devices 110-112. In another arrangement, as shown in FIG. 2, the mobile devices 110-112 can communicate amongst themselves in a peer-to-peer ad-hoc network 120 without infrastructure or WLAN support. For example, the mobile device can use short-range radio communication to engage in a group call in a peer-to-peer mode. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology.

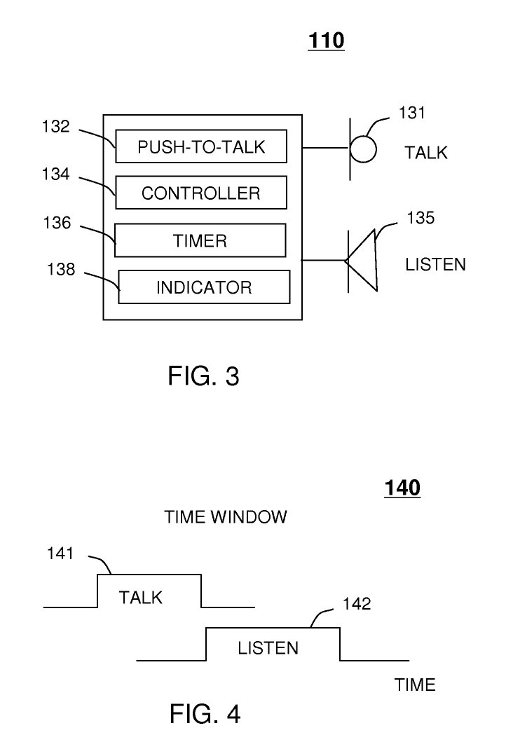

Referring to FIG. 3, a block diagram of a mobile device 110 is shown. The mobile device 110 can be a cell-phone, a personal digital assistant, a portable music player, an electronic map, a navigation system or any other suitable communication device providing voice communication. The mobile device 110 can include a push-to-talk (PTT) key 132 for one-way dispatch voice communication, a controller 134 operatively coupled to the PTT key 132 for establishing and controlling dispatch communication, a timer 136 operatively coupled to the controller 134 for identifying talk window intervals and listen window intervals, and an indicator 138 operatively coupled to the controller 134 for identifying when a talk window is available. The mobile device 110 can include a microphone 131 for capturing voice, or audio, and a speaker 135 for playing voice, or audio, as is known in the art.

Briefly, the controller 134 employs the timer 136 to determine when a user can press the PTT key 132 to acquire control of a talk channel. The timer 136 establishes a time window for the mobile device 110 and identifies when a user can transmit voice on the talk channel. The indicator 138 references the time window to identify when the PTT key 132 can acquire the talk channel. Within the context of the wireless communication system 100, only one user can acquire the talk channel. The talk channel is synonymous with a transmit channel of the mobile device when a user has acquired PTT control. The talk channel allows only one user at a time to speak during the group call. Only the voice of the user that acquires the talk channel can be heard by the other users on the group call. All the other users within the group can only listen while a user is talking.

Referring to FIG. 4, a time window 140 is shown. The time window 140 can include a talk window 141 and a listen window 142. The talk window 141 identifies when the PTT key 132 can be pressed to acquire control of the talk channel. The listen window 142 identifies when the PTT key 132 can not acquire the talk channel. That is, the user can talk during a duration of the talk window 141, but can only talk for the duration of the talk window. Referring to FIG. 1, the indicator 138 identifies when the user can press the PTT key 132 to acquire the talk channel. The indicator 138 can reference the time window 140, and present a first indication for the duration of the talk window 141, and a second indication for the duration of the listen window 142. For example, the indicator 138 may change a backlight to the color green during the talk window 141, and the color to red during the listen window 142. Notably, other means of indication are herein contemplated. For example, the mobile device can vibrate when the timer 136 is in the talk window 141, or the mobile device can play an audible sound when the timer 136 is in the talk window 141. In the latter case, a ring tone or song that is associated with the group call can be played. Notably, different group calls will have different associated songs. This allows the user to identify the call without physically handling the mobile device.

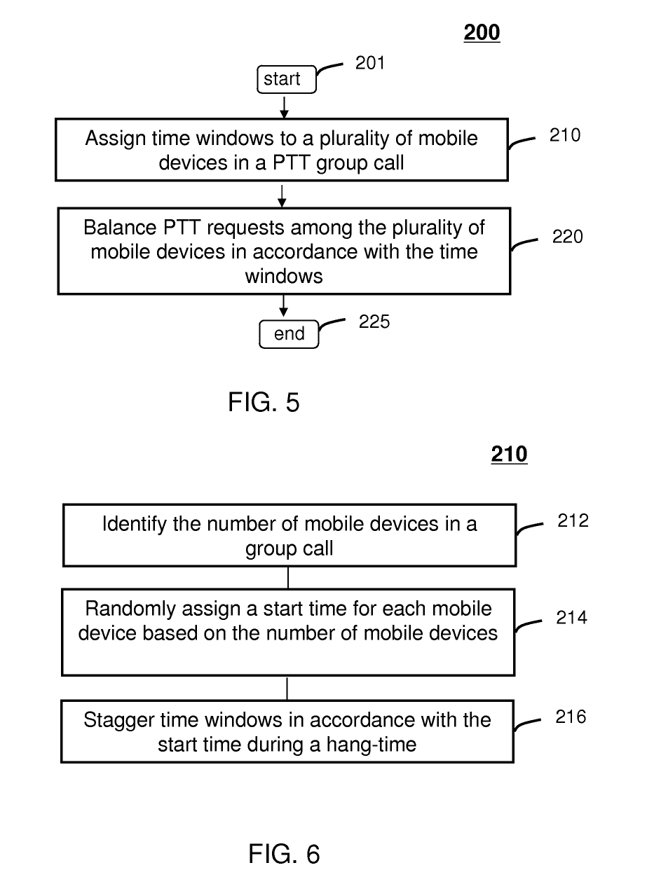

Referring to FIG. 5, a method 200 for managing a push-to-talk group call is shown. The method 200 can be practiced with more or less than the number of steps shown. To describe the method 200, reference will be made to FIGS. 1, and 3-7 and although it is understood that the method 200 can be implemented in any other manner using other suitable components. In addition, the method 200 can contain a greater or a fewer number of steps than those shown in FIG. 5.

At step 201, the method 200 can start. The method 200 can start in a state wherein a first user initiates a group call. At step 202, time windows can be assigned to a plurality of mobile devices in a PTT group call. The time windows determine when a PTT key can acquire a talk channel, and when a talk channel is not available for acquire. As an example, referring back to FIG. 1, each of the mobile devices may be in the group call. Each mobile device 110 may contend for the talk channel during a hang-time interval in accordance with a time window 140 assigned to the mobile device.

Briefly, referring to FIG. 3, the controller 134 of a first mobile device 110 can communicate with the controllers of each of the other mobile devices 111-112 in the group call. In one arrangement, one of the mobile devices 110 can act as the master device to assign time windows for each mobile device in the group call. The master device 110 can be the mobile device that initiates the group call, or that is responsible for inviting participants into the group call. The master device sends a message to all participating devices that provides a seed to randomize the talk and listen windows. The master controller 134 can adjust the time windows for each of the mobile devices as they leave or enter the group call. The controllers for each of the mobile devices, in turn, use the time window assigned to them to enforce transmit times and receive times.

In practice, each controller of a mobile device is responsible for enforcing the talk window 141 and listen window 142 of time window 140 assigned to them. For example, the mobile device will accept a PTT request from the user only if the timer 136 is in a talk window 141. The mobile device will not accept a PTT request the user only if the timer 136 is in a listen window 142. The master device 110 can also receive update requests from a mobile device to adjust a time window of the mobile device. Notably, in this arrangement, the master device 110 does not control the talk channel directly. The master device 110 only assigns and updates the time windows for the other devices. Each of the mobile devices alone is responsible for enforcing the talk 141 and listen 142 intervals of the time window 140 (See FIG. 4).

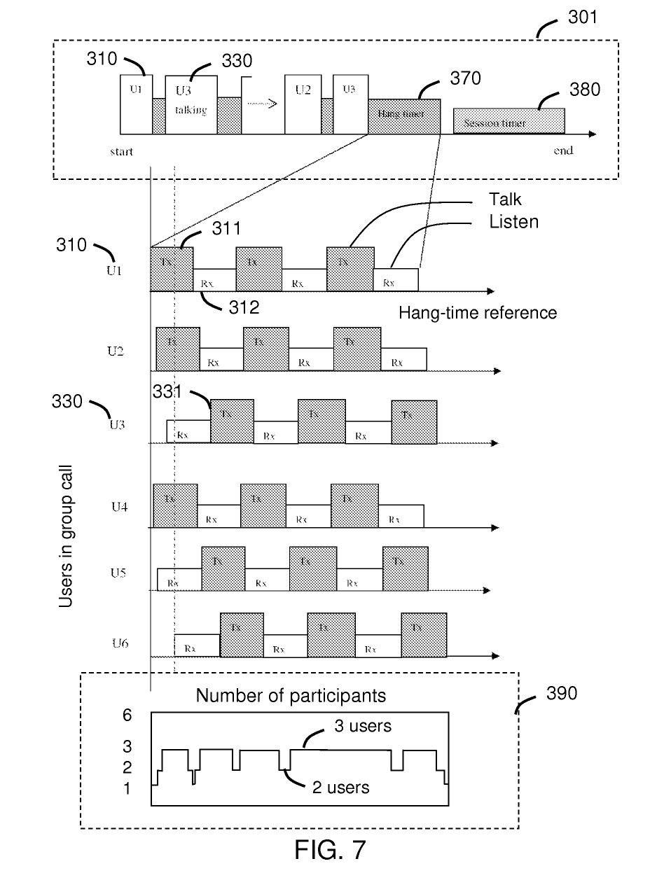

Referring to FIG. 7, a diagram of a group call session is shown. The diagram is pertinent to describing the method 200. Subplot 301 shows an exemplary time line for a talk channel with six users (U1 to U6) participating on the group call. For example, at a first time, user U1 (310) acquires PTT control of the talk channel. The user can talk on the talk channel for a time length given by the talk window 141 of the time window 140 assigned to the user. Upon relinquishing control, or exceeding a duration of the talk window 141, the PTT control is available for other users to acquire. Accordingly, at a second time, user U3 (330) can acquire the PTT control. U3 (330) can then talk for an amount of time specified by a talk window in the assigned time window 140.

Notably, only one user at a time can acquire PTT control of the talk channel. The time between when the talk channel is released and then acquired is the hang-time 370. During the hang-time 370, users can acquire the PTT control in accordance with their assigned time window. It should also be noted, that the users that can acquire the PTT control must still contend for the talk channel. However, the number of users that content for the talk channel is reduced based on the staggering of the time windows. The time windows can be randomly assigned during the hang-time to give user's equal chance of acquiring PTT control. Moreover, the time windows are staggered to reduce the number of users contending for control at any given time. In such regard, each user has an equal chance acquire PTT control during a transmit window 311 of an assigned time window. In particular, each time window has a talk window 141 and a listen window 142. The talk window 141 coincides with a transmit slot (such as 311 for User 1). The listen window 142 coincides with a receive slot (such as 312 for User 1).

Briefly, referring to FIG. 6, the master device 110 can assign the time windows by first identifying the number of mobile devices in the group call (step 212). The master device can determine how many time windows 140 to establish based on the number of users. The master device can also randomly assign a start time for each mobile device based on the number of mobile devices (step 214). The start time identifies when the time window 140 begins. Accordingly, the start time also identifies the times when the user can acquire control. The randomization ensures that each user receives a chance to acquire PTT control over multiple hang-times. The master device can then stagger the time windows in accordance with the start time during a hang-time (step 216). Briefly, the master device can stagger the time windows for the plurality of mobile devices during a hang-time to reduce contention. In effect, the staggering of the time windows and the randomization of the start times during the group call, rotates the order of the users fairly.

For example, referring again to FIG. 7, a start time coincides with a leading edge of a transmit slot. The start time for U1 (310) corresponds to the rising edge of the transmit slot 311. Notably, the start times for each of the users (U1 to U6) is staggered over the hang-time 370. The staggering effectively reduces the number of users contenting for PTT control, since only users with a transmit window can acquire PTT control. In such regard, the number of users contending for control at any particular time is less than if all the users raced for control. For example, the time window 140 for each of the users is staggered within a hang-time 370 to reduce contention. Subplot 390 reveals the total number of users that can acquire the PTT control at any given time within the hang-time. Subplot 390 shows that, on average, 3 users can contend for PTT control, even though there are 6 users on the call in total. Without staggering, all 6 users would be contending for control for each hang-time. Subplot 390 also shows that there are times when only 1 or 2 users contend for PTT control. This further ensures that a user always receives an opportunity to acquire PTT control.

Returning back to FIG. 5, at step 220, the PTT requests among the plurality of mobile devices can be balanced in accordance with the time windows. Balancing PTT requests ensures that users receive an equal opportunity to acquire PTT control. In the foregoing, a description for balancing the requests is provided. At step 225, the method 200 can end.

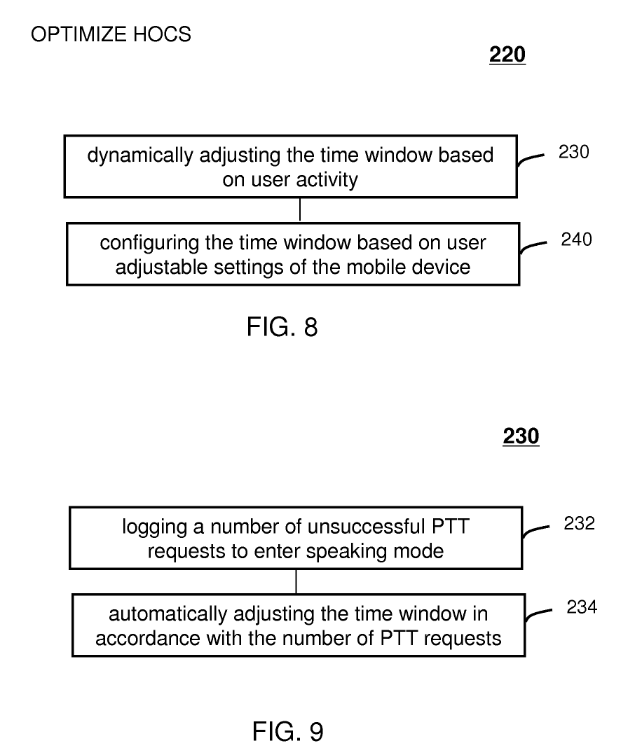

One method for balancing user requests is based on monitoring user activity. For example, referring to FIG. 8, at step 230 PTT requests can be dynamically adjusted based on user activity. For example, referring to FIG. 9, one exemplary implementation for the dynamically adjusting the time windows based on user activity is provided. Briefly, the number of time windows can be adjusted based on the number of unsuccessful attempts to acquire PTT control. For instance, at step 232, the master controller 134 can log a number of unsuccessful PTT requests to enter speaking mode. At step 234, the master controller 134 can automatically adjust the time window in accordance with the number of PTT requests. This provides an ability to change the randomization of the talk and listen windows based on the number of failed or passed attempts to receiving talk privileges on the talk channel.

The time windows can be adjusted based on the number of PTT key presses to give a user more chances of listening or talking. For example, referring back to FIG. 7, three time windows are shown for each user. A time window is a TX and RX pair. That is, each user has only 3 opportunities to talk, wherein the talk time is limited to the TX length. The number of time windows for each user can be adjusted separately. Increasing the number of time windows reduces the available talk time but increases the number of opportunities to speak. Reducing the number of time windows increases the available talk time but decreases the number of opportunities to speak. Notably, the total talk time for any user is the same since the total time is evenly distributed across users.

Referring back to FIG. 8, another method for balancing user requests is provided. That is, at step 240, time windows can be configured based on user adjustable settings. The user adjustable settings identify user preferences during group call. A user preference may be a number of time windows to include during a hang-time. A user preference may be an indication type or an indication level for a talk window 141. For example, the user may prefer to receive a visual indication when the talk window 141 is available, an audible indication, or a vibration effect. As one example, the user can set the colors or the flashing rate of a visual identifier. Moreover, the user can may use the indications to preview the settings. For example, the user may adjust a PTT light flashing, vibration rate, or audible periodicity, to set the number of time windows. The indicator rate can be associated with the talk and listen window intervals. In such regard, the user can interpret visual, auditory, or physical feedback for adjusting the user preferences.

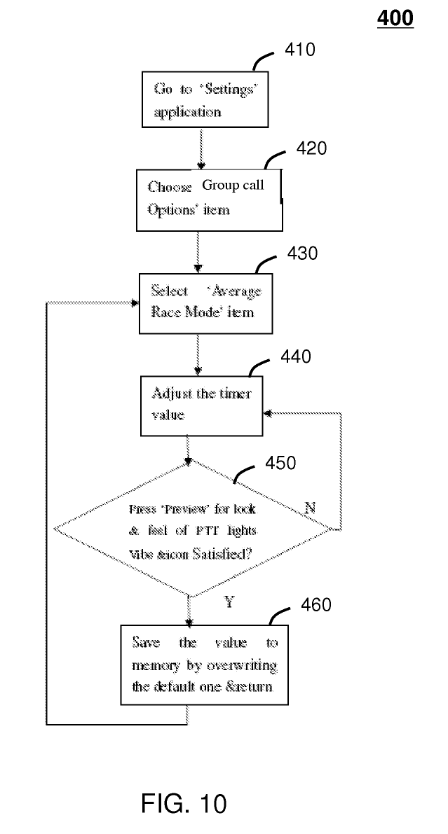

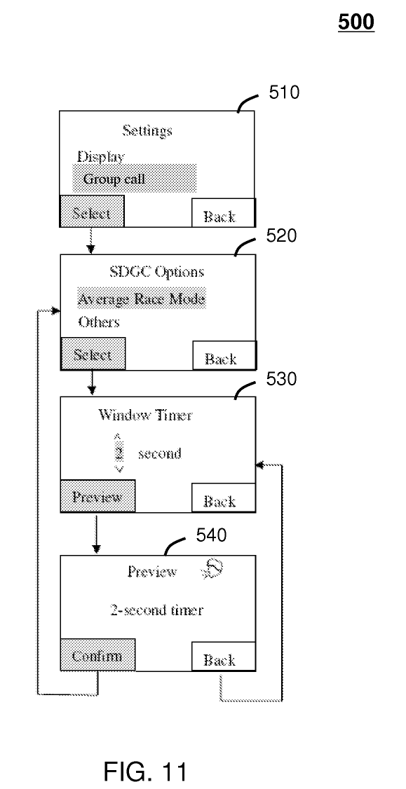

Referring to FIG. 10, an exemplary procedure 400 for setting user preferences is shown. Notably, embodiments of the invention are not limited to the steps of the procedure 400 shown or the order of the steps in the procedure 400. The procedure 400 may include more or less than the number of steps shown. In one embodiment, the procedure 400 can be implemented on a mobile device. The mobile device can include a user interface that presents user input windows in accordance with the procedural steps. Accordingly, reference will be made to FIG. 11 in describing the exemplary procedure. Briefly, FIG. 10 shows a series of user input windows presented in response to each of the procedural steps of FIG. 10.

Referring to FIG. 10, at step 410, a user can go to a “settings” application. The “settings” contains user preferences for set up of a group call. Referring to FIG. 11, the user-window 510 shows a settings panel, which includes an option for group call. Returning back to FIG. 10, at step 420, the user can choose group call. Referring to FIG. 11, the user-window 510 for group call is shown. The user-window 520 can include an “average race mode”. The “average race mode” is merely a description entry for practicing the method 200. Returning back to FIG. 10, at step 430, the user can select “average race mode” to assign time windows to users on the group call for balancing contention to the PTT control. The entry for “average race mode” is an option that is available to the user prior to starting a group call. Returning back to FIG. 10, at step 440, the user can adjust the timer value. The timer value identifies the talk 141 and listen 142 interval of the time window 140. Referring to FIG. 11, the user-window 530 for setting the timer is shown. Returning back to FIG. 10, at step 450 the user can press a preview key. Upon pressing the preview key the user can assess a look and feel of the time window 140 for group call. For example, referring to FIG. 11, the user-window 540 for previewing the look and feel is shown. During the preview, the PTT light can flash in accordance with the talk and listen intervals, allowing the user to visualize the settings. Similarly, vibration and audible cues can be produces for providing another sensory interpretation to the settings. Returning back to FIG. 10, at step 460, the timer value can be saved to memory, which may include overwriting a previous timer value. As one example, the user can save a history of preferences, and revert back to a preference if so desired. Also the user may have different preferences for different group call identifiers. The user can continue to adjust the timer value until a desirable look and feel is achieved. Notably, the look and feel corresponds to the attributes of the time window, particularly the number of time windows selected for a hang-time.

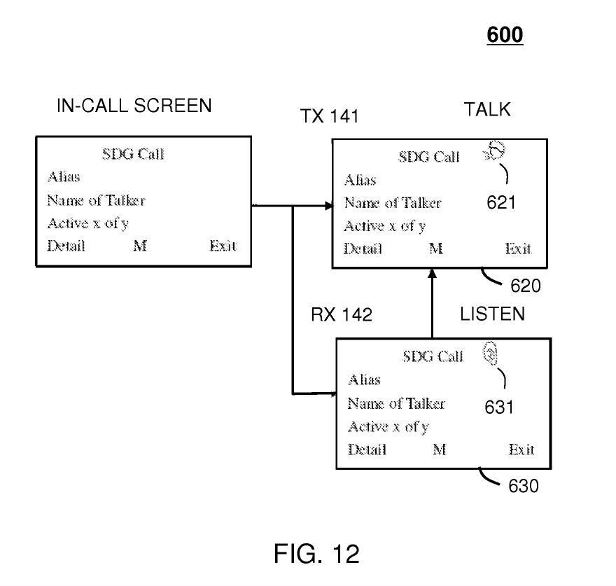

Referring to FIG. 12, an exemplary in-call screen 600 is shown. The in-call screen 600 is a display that can be presented on a mobile device during a group call. The in-call screen 600 identifies that the user is in a call, and identifies one or more modes of the group call. The in-call screen 600 can also present information relevant to the group call, such as a user's name alias, a name of the talker, how active the talker is during the group call, and any details associated with the caller. Notably, the in-call screen identifies the user that currently has acquired of the PTT control.

During group call, the mobile device can be in either talk mode or listen mode. Recall in FIG. 4, the time window 140 identifies a talk window 141 and a listen window 142. Notably, the indicator 138 can change the in-call screen 600 to a talk mode in-call screen 620 or a listen mode in-call screen 630. The talk mode in-call screen 620 can include a talk icon 621, such as an image of a talking person, as a visual indicator. The presentation of the talk icon 621 informs the user when control of the PTT can be acquired. The indicator 138 presents the talk icon 621 in accordance with the talk window 141 (e.g. transmit window) of the time window assigned to the user. Similarly, the listen in-call screen 630 can include a listen icon, such as an image of an ear, as a visual indicator. The presentation of the listen icon 631 informs the user that the PTT control cannot be acquired. The controller 134 will prevent the mobile device from PTT communication, if the user presses the PTT key 132 to speak. The controller 134 only allows the mobile device to perform PTT communication if the timer 136 identifies that the mobile device is in the talk window 141. In another arrangement, the indicator 138 can provide vibration effects for differentiating talk mode and listen mode.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiment of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for managing a push-to-talk (PTT) group call, comprising:
assigning time windows to a plurality of mobile devices in a PTT group call, wherein a time window identifies whether a mobile device is in a talking mode or a listening mode; and
balancing PTT requests among the plurality of mobile devices in accordance with the time windows to reduce talking request contention.

2. The method of claim 1, wherein the step of balancing PTT requests further comprises
for each mobile device, identifying a time window for talking and listening, wherein the time window includes:
a talk window for providing a talking interval; and
a listen window for providing a listening interval,
wherein a mobile device enters the talking mode in response to a PTT request during the talk window.

3. The method of claim 1, further comprising randomizing a start of the time windows among the plurality of mobile devices

4. The method of claim 1, further comprising staggering time windows for the plurality of mobile devices during a hang-time of the PTT group call.

5. The method of claim 1, further comprising dynamically adjusting the time window based on user activity.

6. The method of claim 1, further comprising configuring the time window based on user adjustable settings of the mobile device.

7. The method of claim 5, further comprising:
logging a number of unsuccessful PTT requests to enter talking mode; and
automatically adjusting the time window in accordance with the number of PTT requests.

8. The method of claim 2, further comprising:
changing a PTT status light to coincide with the talk window or the listen window,
wherein at least one PTT status light identifies when the PTT request activates talking mode.

9. The method of claim 1, further comprising:
detecting a user request for configuring the time window;
providing a haptic representation of the talking interval and the listening interval; and
adjusting the time window in accordance with user feedback, wherein a haptic representation is an audio, visual, or vibration effect.

10. The method of claim 1, establishing a plurality of time windows during a hang-time of the PTT group call.

11. A system for push-to-talk (PTT) group call, comprising:
a plurality of mobile devices each having a PTT key to make a PTT request, the plurality of mobile devices each having a controller that enforces a time window for a PTT request, the time window identifying a talking interval and a listening interval,
wherein a first mobile device generates the time windows for the plurality of mobile devices and balances multiple PTT requests among the plurality of mobile devices in view of the time windows to reduce talking request contention during the PTT group call.

12. The system of claim 11, wherein the first mobile device includes
a controller for identifying mobile devices in the PTT group call and determining when a mobile device is in a talking mode or a listening mode; and
a timer for tracking talking windows and listening windows of the plurality of mobile devices.

13. The system of claim 12, wherein the controller staggers time windows during a hang-time of the PTT group call such that a number of talking intervals is randomly distributed across a duration of the PTT group call.

14. The system of claim 12, wherein the controller automatically adjusts the time windows for plurality of mobile devices based on user activity or user preference settings.

15. The system of claim 14, wherein the controller changes an order of the talking interval and the listening interval in a time window to increase talking mode probability.

16. A mobile device, comprising
a controller for sending and receiving audio data during a push-to-talk (PTT) group call;
a push-to-talk (PTT) key operatively coupled to the controller for activating a talking mode; and
a controller operatively coupled to the PTT key and the controller for controlling when the PTT key activates the talking mode in accordance with a time window.

17. The mobile device of claim 16, further comprising:
a timer communicatively coupled to the controller for establishing a time window, the time window having a talking interval and a listening interval,
wherein the PTT key activates the talking mode when the timer is within the talking interval, and disables talking mode when the timer is within the listening interval.

18. The mobile device of claim 16, further comprising:
a user interface for adjusting the time window and saving user preference settings associated with the adjusting,
wherein the user interface provides a haptic representation of the time window during the adjusting, wherein the haptic representation is an audio, visual, or vibration effect.

19. The mobile device of claim 18, wherein a visual representation is presented through a back light, such that a first illumination of the back light identifies when a user can enter talking mode, and a second illumination of the back light identifies when a user cannot enter talking mode.

20. The mobile device of claim 18, wherein the user interface presents an in-call screen during the PTT group call having icons or messages that identify when a PTT request activates talking mode.
